(19) United States
(12) Patent Application Publication
(10) Pub. No.: US 2012/0215647 A1
(43) Pub. Date: Aug. 23, 2012

(54) SYSTEMS AND METHODS FOR PROMOTING PRODUCTS AND SERVICES

(76) Inventors: Ken R. Powell, Watkinsville, GA (US); John W. Daniel, Watkinsville, GA (US)

(21) Appl. No.: 13/031,955

(22) Filed: Feb. 22, 2011

(51) Int. Cl. G06Q 30/00

(52) U.S. Cl. 705/16; 705/26.1

(57) ABSTRACT

Disclosed are systems and methods for promoting products and services in a retail environment.

### FIELD OF THE INVENTION

This invention relates generally to systems and methods for promoting products and services and, more particularly, to systems and methods for promoting products and services in a retail environment.

### SUMMARY OF THE INVENTION

According to an aspect of the present invention, in a system including a server operated on behalf of a first entity, a store operated on behalf of a second entity, the first entity being non-affiliated with the second entity, a plurality of customers each possessing a portable electronic device, each portable electronic device configured to receive a first signal thru a communication network from a computer, each portable electronic device configured to access the computer via the communication network, there is a processing system in the store. The processing system comprises a near field communication receiver configured to receive the first signal from the portable electronic device; and circuitry configured to receive the first signal from the near field communication, receiver, send the first signal to the server, receive a second signal from the server, and cause a point of sale system to display an amount due, the amount due depending on the second signal.

According to another aspect of the present invention, in a system including a server operated on behalf of a first entity, a store operated on behalf of a second entity, the first entity being non-affiliated with the second entity, a plurality of customers each possessing a portable electronic device, each portable electronic device configured to receive a first signal thru a communication network from a computer, each portable electronic device configured to access the computer via the communication network, there is a method performed in the store. The method comprises receiving a first signal from the portable electronic device, by using a near field communication circuitry; sending the received first signal to the server; receiving a second signal from the server; and displaying an amount due, responsive to the received the second signal.

According to yet another aspect of the present invention, in a system including a server operated on behalf of a first entity, a store operated on behalf of a second entity, the first entity being non-affiliated with the second entity, a plurality of customers each possessing a portable electronic device, each portable electronic device configured to receive a first signal thru a communication network from a computer, each portable electronic device configured to access the computer via the communication network, there is a processing system in the store, the processing system comprises means for receiving a first signal from the portable electronic device, by using a near field communication circuitry; means for sending the received first signal to the server; means for receiving a second signal from the server; and means for displaying an amount due, responsive to the received the second signal.

### BRIEF DESCRIPTION OF THE DRAWINGS

References are made to the following text taken in connection with the accompanying drawings, in which:

FIG. 1 shows an exemplary system according to an embodiment of the present invention.

FIG. 2 shows a retail store configured to perform processing in accordance with an exemplary embodiment.

FIGS. 3A and 3B show a portable, personal electronic device carried by consumers in the exemplary system.

FIG. 4 is a diagram emphasizing a data path in the exemplary system.

FIG. 5 shows a processing performed in the exemplary system.

FIG. 6 shows another processing performed in the exemplary system.

FIG. 7 shows an exemplary system according to a second embodiment of the present invention.

FIG. 8 shows a retail store configured to perform processing in accordance with an exemplary embodiment.

FIG. 9 shows a retail store configured to perform processing in accordance with a third embodiment.

FIG. 10 is a diagram describing other exemplary systems.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY SYSTEMS

### First Exemplary System

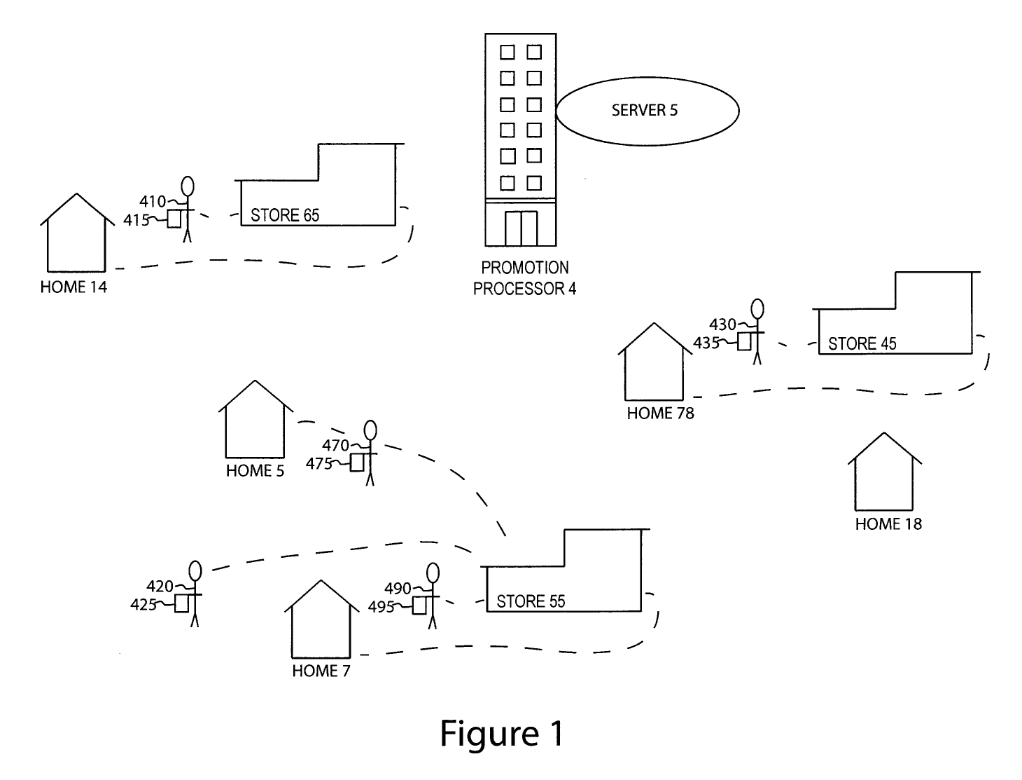

FIG. 1 shows exemplary system 1 according to a preferred embodiment of the present invention. System 1 includes a promotion offer processor 4 that operates a server 5. Server 5 receives signals from and send signals to, retail stores 45, 55, and Processor 4 and store 45 are non-affiliated, meaning that they are not affiliates with respect to each other. In this patent application, concerns are affiliates of each other when one concern controls or has the power to control the other, or a third party or parties controls or has the power to control both. Power to control is described in Section 121 of the U.S. regulations of the Small Business Administration.

Processor 4 and store 55 are non-affiliated.

Processor 4 and store 65 are non-affiliated.

Store 45 and store 55 are non-affiliated.

Store 45 and store 65 are non-affiliated.

Store 55 and store 65 are non-affiliated.

System 1 includes multiple persons, such as person 410, person 420, person 430, person 470, and person 490. Person 490 resides in home 7. While in home 7, person 490 manipulates a control on portable telephone 495 to request a description of available promotional offer or offers and then portable telephone 495 receives the description of the promotional offer or offers via a mobile phone communication signal. In this example, the request for the description of available promotional offers happens outside of the retail stores. A promotional offer is an offer provided to induce a person such as person 490 to purchase goods or services and a promotional offer may be in the form of an electronic coupon where the price of the product purchased is to be reduced by a specified amount, an electronic voucher where a person such as person 490 has purchased a product or service at a discounted price and the voucher is provided to confirm the person purchased the product or service, or a loyalty event where a person such as person 490 is provided with a discount off of goods or services for engaging in an activity or series of activities set by the offeror of the promotional offer as required to realize the discount. Redemption of a coupon, redemption of a voucher, and redemption of a loyalty event are each a type of reward.

From the description of available promotional offer or offers displayed on her portable telephone, person 490 selects the desired promotional offer or offers. A selected offer may be applicable to store 55 and non applicable to establishments non-affiliated with store 55. Subsequently, person 490 goes to store 55, carrying her portable telephone 495.

Person 470 resides in home 5. While outside of home 5, person 490 manipulates a control on portable telephone 475 to request a description of available promotional offer or offers and then portable telephone 475 receives the description of the promotional offer or offers via a mobile phone communication signal. From the description of available promotional offer or offers displayed on his portable telephone, person 470 selects the desired promotional offer or offers. Subsequently, person 470 goes to store 55, carrying his portable telephone 495.

While riding in a vehicle, person 420 manipulates a control on portable telephone 425 to request a description of available promotional offer or offers and then portable telephone 425 receives the description of the promotional offer or offers via a mobile phone communication signal. From the description of available promotional offer or offers displayed on her portable telephone, person 420 selects the desired promotional offer or offers. Subsequently, person 420 goes to store 55, carrying her portable telephone 425.

Person 410 resides in home 14. Person 410 manipulates a control on portable telephone 415 to request a description of available promotional offer or offers and then portable telephone 415 receives the description of the promotional offer or offers via a mobile phone communication signal. From the description of available promotional offer or offers displayed on her portable telephone, person 410 selects the desired promotional offer or offers. A selected offer may be applicable to store 65 and non applicable to establishments non-affiliated with store 65. Subsequently, person 410 goes to store 65, carrying her portable telephone 415.

Person 430 resides in home 78. Person 430 manipulates a control on portable telephone 435 to request a description of available promotional offer or offers and then portable telephone 435 receives the description of the promotional offer or offers via a mobile phone communication signal. From the description of available promotional offer or offers displayed on her portable telephone, person 430 selects the desired promotional offer or offers. A selected offer may be applicable to store 45 and non applicable to establishments non-affiliated with store 45. Subsequently, person 430 goes to store 45, carrying her portable telephone 435.

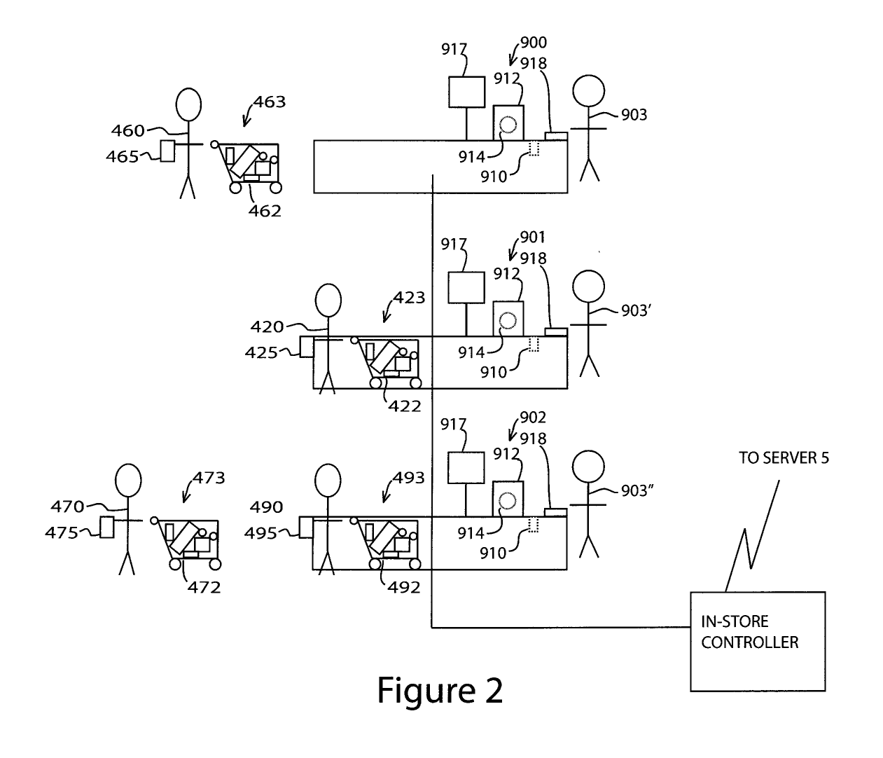

FIG. 2 is a partial view of store 55. Store 55 has a plurality of product areas, each corresponding to a respective product, and checkout stations 900, 901, and 902. Each checkout station includes an electronic or computerized point of sale device, an internal or external printer, a cash receipt drawer, a bar code reader 910 that detects an optical (electromagnetic) signal reflected from a bar code, and a magnetic stripe reader or a credit/debit card terminal.

Checkout station 900 includes near-field communication circuitry 912 having loop antenna 914, checkout station 901 includes near-field communication circuitry 912 having loop antenna 914, and checkout station 902 includes near-field communication circuitry 912 having loop antenna 914.

In this patent application, the word circuitry encompasses dedicated hardware, and/or programmable hardware, such as a CPU or reconfigurable logic array, in combination with programming data, such as sequentially fetched CPU instructions or programming data for a reconfigurable array.

Upon completion of shopping, each customer brings selected products from the shelves to checkout station 900, 901, or 902.

Each customer uses her portable telephone to communicate the promotional offer or offers she has selected to Checkout station using a near-field communication signal sent from the portable telephone to the Checkout station. For example, customer 490 uses her portable telephone 495 to send a code that is unique to both Customer 490 and the promotional offer or offers she selected to Checkout station 902.

Customer 490 completes the purchase of her selected products 493 by transferring products 493 from her cart 492 to station 902. Checkout clerk 903″ scans each selected product past bar code reader 910, or enters the product selection information manually via keyboard 918.

Near field communication circuitry 912 enables the exchange of data with portable telephones over about a 10 centimeters distance. Circuitry 912 communicates via magnetic field induction, via loop antenna 914, operating within the radio frequency ISM band of 13.56 MHz. Most of the RF energy is concentrated in the allowed 14 kHz bandwidth range.

Near-field communications circuitry 912, in station 902, receives the signal containing the unique code for the promotional offer from portable telephone 495 via loop antenna 914.

Station 902 then sends the unique promotional offer code to an in-store controller, which is common to each of stations 900, 901, at 902. The in-store controller of retail store 55 then sends the unique promotional offer code to server 5, which is common to each of retail stores 45, 55, and 65. Server 5 determines whether the unique promotional offer code is valid for Consumer 490 and if it is valid then sends an indication result that may or may not contain instructions to adjust the amount due by Consumer 490 based upon the terms of the promotional offer to the in-store controller of store 55, which sends the indication result to checkout station 902.

Checkout station 902 conditionally lowers an amount due, depending on the indication result received.

Checkout station 902 completes processing to determine the total amount due from consumer 490, and display the total amount due, from consumer 490, on display 917. Checkout station 902 may also display the total amount due, from consumer 490, on a printer.

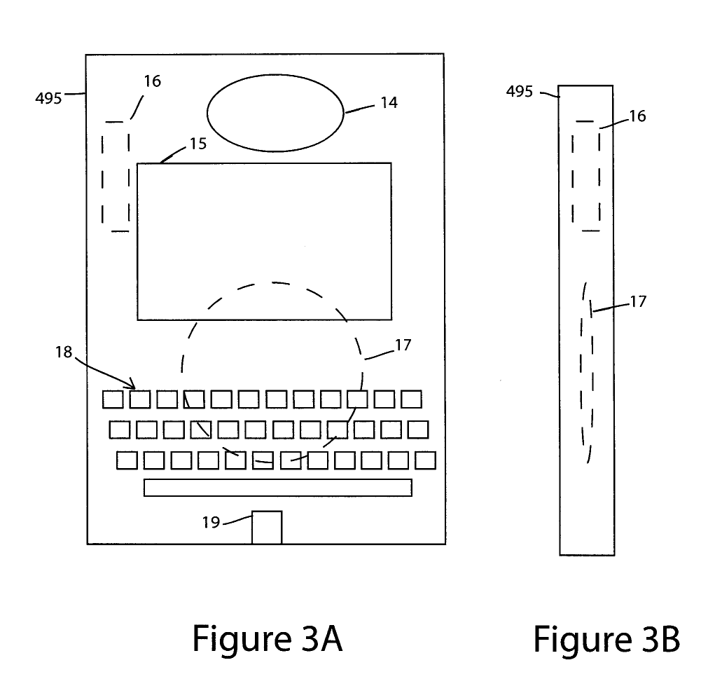

FIG. 3A shows a front view, and FIG. 3B shows a side view, of portable telephone 495 carried by person 490. Telephone 495 includes an internal antenna 16 for transmission and reception of voice signals, and for request and reception of information pertaining to available promotional offers, as described in more detail below.

Telephone 495 includes near-field communication circuitry having internal loop antenna 17 for transmission of promotional offers or promotional offer codes available only to a specific user at a specific location.

Telephone 495 also includes a speaker 14, a display screen 15, a means to enter data via a keyboard 18 or alternatively a touch keyboard display, and a microphone 19 in addition to other internal circuitry.

Each of telephones 415, 435, 475, and 425 the circuitry contained in telephone 495.

Customer 470 completes the purchase of his selected products 473 by transferring products 473 from his cart 472 to station 902. Checkout clerk 903″ scans each selected product past bar code reader 910, or enters the product selection information manually via keyboard 918.

Customer 420 completes the purchase of her selected products 423 by transferring products 423 from her cart 422 to station 901. Checkout clerk 903 scans each selected product past bar code reader 910, or enters the product selection information manually via keyboard 918.

Customer 460 completes the purchase of her selected products 463 by transferring products 463 from her cart 462 to station 900. Checkout clerk 903 scans each selected product past bar code reader 910, or enters the product selection information manually via keyboard 918.

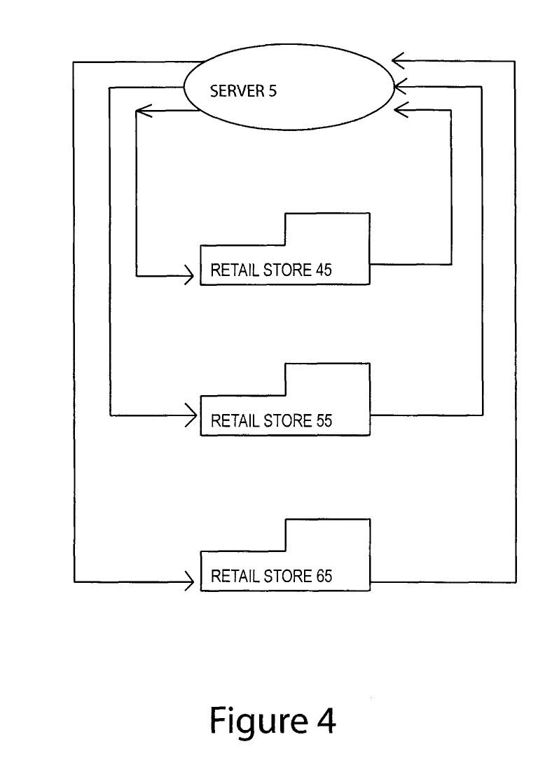

FIG. 4 emphasizes other aspects of system 1. System 1 includes server 5, operated by promotional offer processor 4. Server 5 communicates with retail stores 45, 55 and 65, via a data communication network such as the Internet.

In response to a certain signal from server 5, store 55, for example, allows a customer transaction to proceed with a discounted price or a loyalty event.

More specifically server 5 receives a unique promotional code from portable telephone 495 transmitted by store 55, to access an entry in a database. Depending on the data in the entry in the database, server 5 conditionally responds to store 55 with a signal that includes, if appropriate, an indication that the amount due from the Consumer is to be reduced or a loyalty event is to be credited or rewarded, causing station 902 to allow customer 490 to redeem the promotional offer (e.g. pay a discounted price).

Otherwise server 5 sends a not-authorized signal to store 55.

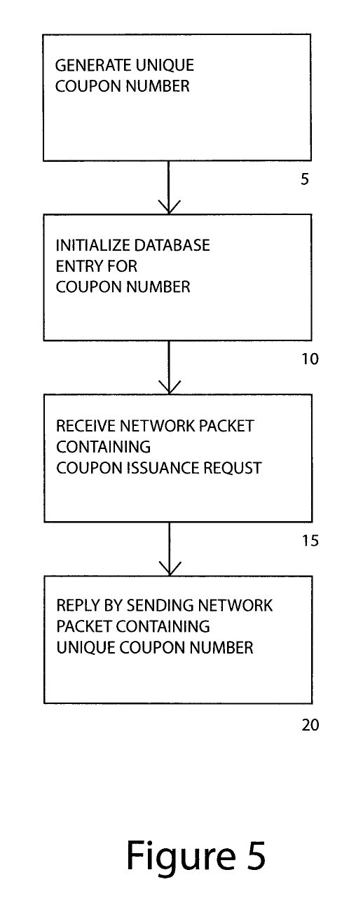

FIG. 5 shows a processing performed in system 1. System 1 generates a unique promotional code, to be issued to only one consumer at a time (step 5). System 1 initializes a database entry for the unique promotional code: promotional offer_database [new_promotional offer_number, redeemed]=false. (Step 10).

System 1 receives a network packet containing a request to receive the information required to accept and use a promotional offer, originating from a portable device such as portable telephone 495 carried by consumer 490. (Step 15). System 1 replies to the packet received in step 15, by sending a reply packet containing a unique promotional offer code to the portable device.

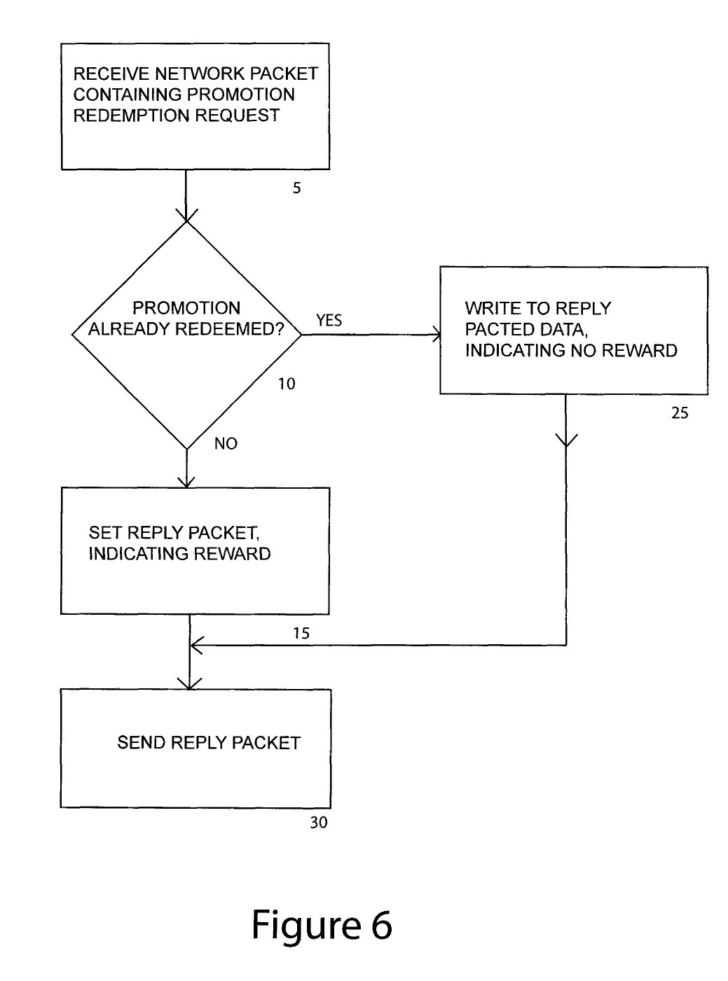

FIG. 6 shows a processing performed by server 5. Server 5 receives a network packet containing a request to determine if a unique promotional code is valid from a Checkout station within store 55 where the unique promotional code originated from a signal received by such Checkout station from a portable device such as portable telephone 495 carried by consumer 490 (see step 5). Server 5 determines whether the promotional offer code is available to the specific Consumer making the request: promotional_offer_database [new_offer_number, available]=true? (Step 10). If the promotional offer is available for use by the specific Consumer, server 5 sets reply packet data to indicate that a redemption is authorized (see step 15).

If the requested promotional offer has already been redeemed or is otherwise unavailable to the specific consumer at that time, server 5 sets reply packet data to indicate a redemption is not authorized (Step 25).

Server 5 sends the reply packet to the retail store that sent the promotional offer code redemption request (step 30).

Each of stores 45 and 65 includes the circuitry that is in store 55.

### Second Exemplary System

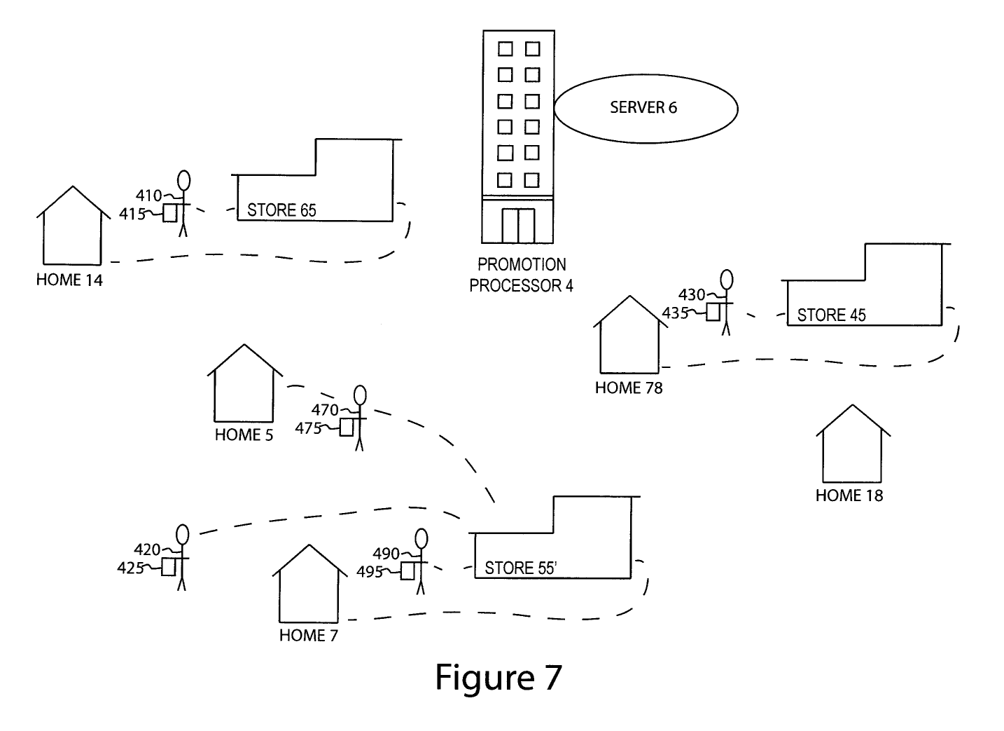

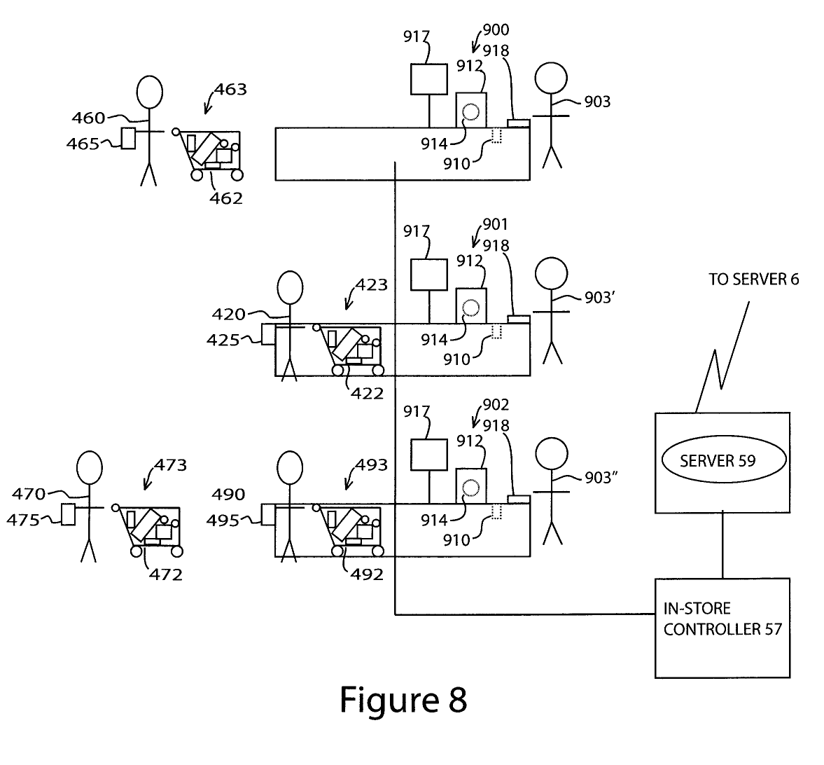

FIGS. 7 and 8 shows system 2 in accordance with a second exemplary system.

Periodically, server 6 sends to store 55′ a signal that includes offers available to potential customers of store 55′. Separate in-store server 59 in communication with the in-store controller 57 stores the information received from Server 6.

Station 902 sends a unique promotional offer code to in-store controller 57, which is common to each of stations 900, 901, at 902. In-store controller 57 relays the code to a separate in-store server 59. In-store server 59 contains a determiner that upon receipt of the unique promotional offer code uses the stored information, previously received from server 6 to determine whether the unique promotional offer code is valid for consumer 490. If the unique promotional offer code is valid, server 59 sends an indication result to station 902 that may or may not contain instructions to adjust the amount due by consumer 490 based upon the terms of the promotional offer sent by Server 6 and stored within in-store server 59 in communication with the in-store controller 57.

Checkout station 902 conditionally lowers an amount due, updates loyalty program information for the specific consumer, or both, depending on the indication result received.

Alternatively, the indication result received by checkout station 902 contains the adjusted amount due, updates to loyalty program information for the specific consumer, or both, based upon the promotional offer.

Checkout station 902 then completes processing to determine the total amount due from Consumer 490 on display 917.

### Third Exemplary System

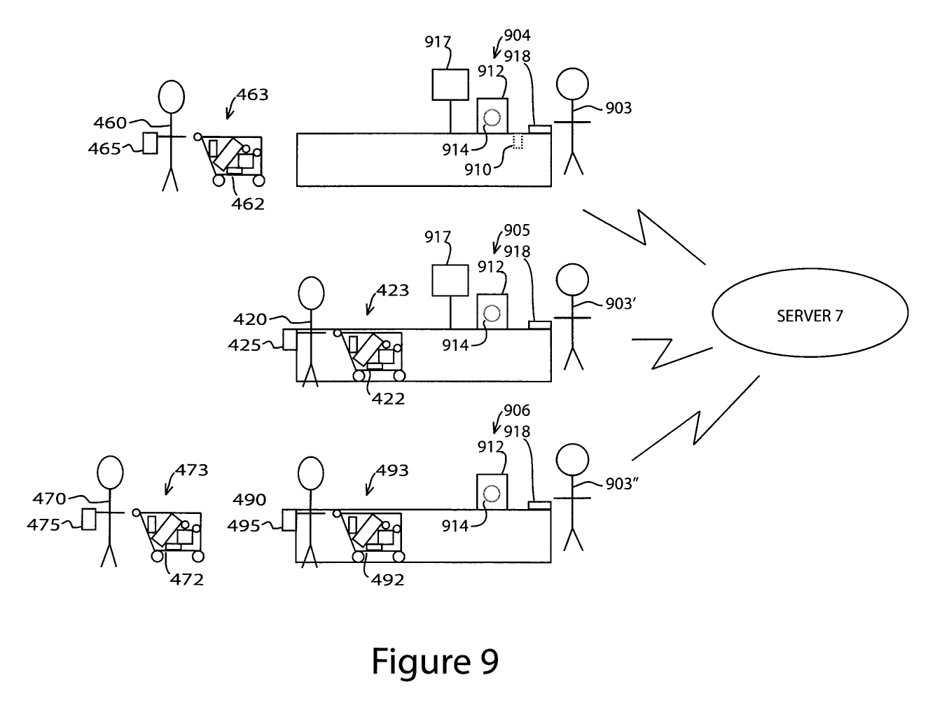

FIG. 9 shows exemplary system 3 according to a third preferred embodiment of the present invention. System 3 includes a promotion offer processor that operates a server 6. Server 6 receives signals from and send signals to retail stores 45′, 55′, and 65′.

Store 65′ has a plurality of products or provides a service such as a restaurant, and has one or more checkout stations and, in this example, checkout stations 904, 905, and 906.

The checkout stations, 904, 905, and 906, each include near-field communication circuitry 912 having loop antenna 914.

Checkout station 904 includes an electronic or computerized point of sale device, an internal or external printer, a cash receipt drawer, a bar code reader 910 that detects an optical (electromagnetic) bar code, and/or a magnetic stripe reader or a credit/debit card terminal. Where checkout station 905 has the following: an electronic or computerized point of sale device, an internal or external printer, and an internal or external magnetic stripe reader or a credit/debit card terminal. Check out station 906 includes a point of sale means with a credit/debit card device.

Upon completion of shopping, each customer brings selected products from the shelves or the bill for services or products received to checkout station 904, 905, or 906 to complete purchase.

Each customer uses her portable telephone to communicate the promotional offer or offers she has selected to checkout station using a near-field communication signal sent from the portable telephone to the Checkout station. For example, customer 470 uses her portable telephone 475 to send a code that is unique to both customer 470 and the promotional offer or offers she selected to checkout station 904.

Customer 470 completes the purchase of her selected products 494 by transferring products 494 to station 904. Checkout clerk 903″ scans each selected product past bar code reader 910 or enters the product selection information manually via keyboard 918.

Near-field communications circuitry 912, in station 906, receives the signal containing the unique code for the promotional offer from portable telephone 475 via loop antenna 914.

Station 906 then sends the unique promotional offer code, which may include specific item level detail, to server 7, which is common to each of retail stores 45, 55, and 65. Server 7 determines whether the unique promotional offer code is valid for consumer 470 and if it is valid then sends an indication result that may or may not contain instructions to adjust the amount due by consumer 470 based upon the terms of the promotional offer to checkout station 904 within store 55.

Checkout station 906 rewards the promotion to the consumer, by conditionally lowers an amount due, depending on the indication result received.

Checkout station 906 completes processing to determine the total amount due from consumer 470.

Each of checkout station is in store 65′ send signals to server 7, which is outside of store 65′, without passing the signals to an in-store controller, or other circuitry, that is common to station 904, 905, and 906.

### Other Exemplary Systems

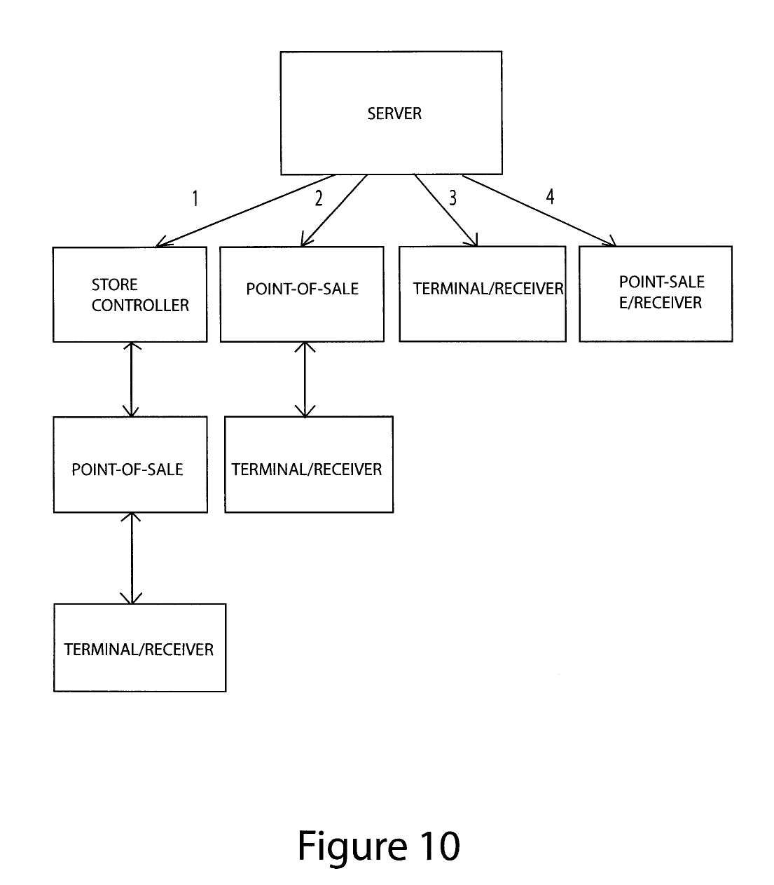

FIG. 10 shows technical and business processes for alternative methods to process a promotional offer using near field communication (NFC) in a electronic portable device, a card, or sticker attached to property of a consumer.

As shown, alternative computer networks include four alternatives.

According to a first network type, there is a coupon processing system in a system including a computer network connecting a server system, a plurality of store controllers and optionally regional controllers, a plurality of store point of sale devices, a plurality of customers each possessing a portable electronic device, a portable electronic device receives one or more coupons or a description of one or more coupons in a signal (message set) thru a communication network from a computer, the portable electronic device accesses a computer via the communication network or retains in memory eligibility for one or more coupons within the device. The coupon processing system comprises a portable electronic device in the proximity of a near field communication receiver associated with a point of sale device; a near field communication receiver connected to (or alternatively contained within) a point of sale system receives the coupon request communicated by the portable electronic device; a store controller receives the coupon request communicated by the point of sale system; a determiner within server connected to the computer network determines whether a coupon corresponds to the coupon signal has been previously processed; a transmitter within the server sends coupon information thru the network to point of sale for total receipt adjustment; and periodically the point of sale system communicates the redemption of the coupon event across a network to one or more computer servers for the purposes of transaction processing, marketing, accounting, and information analysis.

According to the first network type, there is a coupon processing system in a system including a computer network connecting a server system, a plurality of store controllers and optionally regional controllers, a plurality of store point of sale devices, a plurality of customers each possessing a portable electronic device, a portable electronic device receives one or more coupons or a description of one or more coupons in a signal (message set) thru a communication network from a computer, the portable electronic device accesses a computer via the communication network or retains in memory eligibility for one or more coupons within the device. The coupon processing system comprises a computer server periodically downloads consumer coupon eligibility information to the store controller (optionally to or via a regional controller); a portable electronic device in the proximity of a near field communication receiver associated with a point of sale device; a near field communication receiver connected to (or alternatively contained within) a point of sale system receives the coupon request communicated by the portable electronic device; a store controller receives the coupon request communicated by the point of sale system; a determiner within the store controller (optionally regional controller) connected to the computer network determines whether a coupon corresponds to the coupon signal has been previously processed; a transmitter within the store controller (optionally regional controller) sends coupon information thru the network to point of sale for total receipt adjustment; the point of sale system conditionally communicates the redemption of the coupon event across the computer network to the store controller (optionally regional controller); and a store controller (optionally regional controller) periodically transmits redemption information to one or more computer servers for the purposes of transaction processing, marketing, accounting, and information analysis.

According to the first network type, there is a coupon processing system in a system including a computer network connecting a server system, a plurality of store controllers and optionally regional controllers, a plurality of store point of sale devices, a plurality of customers each possessing a portable electronic device, a portable electronic device receives one or more coupons or a description of one or more coupons in a signal (message set) thru a communication network from a computer, the portable electronic device accesses a computer via the communication network or retains in memory eligibility for one or more coupons within the device. The coupon processing system comprises a computer server periodically downloads consumer coupon eligibility information thru the store controller (optionally the regional controller) system to the point of sale system; a portable electronic device in the proximity of a near field communication receiver associated with a point of sale device; a near field communication receiver connected to (or alternatively contained within) a point of sale system receives the coupon request communicated by the portable electronic device; a determiner within the point of sale system connected to the computer network determines whether a coupon corresponds to the coupon signal has been previously processed; a determiner within the point of sale system adjusts total receipt; periodically the point of sale system communicates the redemption of the coupon event across the computer network to the store controller (optionally regional controller); and a store controller (optionally regional controller) periodically transmits redemption information to one or more computer servers for the purposes of transaction processing, marketing, accounting, and information analysis.

According to a second network type, there is a coupon processing system in a system including a computer network connecting a server system, a plurality of store point of sale devices, a plurality of customers each possessing a portable electronic device, a portable electronic device receives one or more coupons or a description of one or more coupons in a signal (message set) thru a communication network from a computer, the portable electronic device accesses a computer via the communication network or retains in memory eligibility for one or more coupons within the device. The coupon processing system comprises a portable electronic device in the proximity of a near field communication receiver associated with a point of sale device; a near field communication receiver connected to (or alternatively contained within) the point of sale receives the coupon request communicated by the portable electronic device; a determiner within the server computer connected to computer network determines whether a coupon corresponds to the coupon signal has been previously processed; a transmitter that sends coupon information thru the computer network to point of sale for total receipt adjustment; and periodically the point of sale system communicates the coupon event across a network to one or more computer servers for the purposes of transaction processing, marketing, accounting, and information analysis.

According to the second network type, there is a coupon processing system in a system including a computer network connecting a server system, a plurality of store point of sale devices, a plurality of customers each possessing a portable electronic device, a portable electronic device receives one or more coupons or a description of one or more coupons in a signal (message set) thru a communication network from a computer, the portable electronic device accesses a computer via the communication network or retains in memory eligibility for one or more coupons within the device. The coupon processing system comprises a computer server periodically downloads consumer coupon eligibility information to the point of sale system; a portable electronic device in the proximity of a near field communication receiver associated with a point of sale device; a near field communication receiver connected to (or alternatively contained within) the point of sale receives the coupon request communicated by the portable electronic device; a determiner within the point of sale system connected to the computer network determines whether a coupon corresponds to the coupon signal has been previously processed; a determiner within the server point of sale provides a total receipt adjustment; and periodically the point of sale system communicates the redemption of the coupon event across the computer network to one or more computer servers for the purposes of transaction processing, marketing, accounting, and information analysis.

According to a third network type, there is a coupon processing system in a system including a computer network connecting a server system, a plurality of terminal systems, a plurality of customers each possessing a portable electronic device, a portable electronic device receives one or more coupons or a description of one or more coupons in a signal (message set) thru a communication network from a computer, the portable electronic device accesses a computer via the communication network or retains in memory eligibility for one or more coupons within the device. The coupon processing system comprises a portable electronic device in the proximity of a near field communication receiver associated with a terminal system; a near field communication receiver (external or internal) associated with a terminal system receives the coupon request communicated by the portable electronic device; a determiner within the server computer connected to computer network determines whether a coupon corresponds to the coupon signal has been previously processed; a transmitter that sends coupon information thru the computer network to terminal system for total receipt adjustment; and periodically the terminal system communicates the coupon event across a network to one or more computer servers for the purposes of transaction processing, marketing, accounting, and information analysis.

According to the third network type, there is a coupon processing system in a system including a computer network connecting a server system, a plurality of terminal systems, a plurality of customers each possessing a portable electronic device, a portable electronic device receives one or more coupons or a description of one or more coupons in a signal (message set) thru a communication network from a computer, the portable electronic device accesses a computer via the communication network or retains in memory eligibility for one or more coupons within the device. The coupon processing system comprises a computer server periodically downloads consumer coupon eligibility information to the terminal system; a portable electronic device in the proximity of a near field communication receiver associated with a terminal (external or internal); a near field communication receiver associated with the terminal receives the coupon request communicated by the portable electronic device; a determiner within the terminal system determines whether a coupon corresponds to the coupon signal has been previously processed; a determiner within terminal system adjusts the total receipt; and periodically the terminal system communicates the redemption of the coupon event across the computer network to one or more computer servers for the purposes of transaction processing, marketing, accounting, and information analysis.

According to a fourth network type, there is a coupon processing system in a system including a computer network connecting a server system, a plurality of point of sale systems, a plurality of customers each possessing a portable electronic device, a portable electronic device receives one or more coupons or a description of one or more coupons in a signal (message set) thru a communication network from a computer, the portable electronic device accesses a computer via the communication network or retains in memory eligibility for one or more coupons within the device. The coupon processing system comprises a portable electronic device in the proximity of a near field communication receiver associated or contained within a point of sale device; a near field communication receiver (external or internal) associated with a point of sale system receives the coupon request communicated by the portable electronic device; a determiner within the server computer connected to computer network determines whether a coupon corresponds to the coupon signal has been previously processed; a transmitter that sends coupon information thru the computer network to point of sale for total receipt adjustment; and periodically the point of sale system communicates the coupon event across a network to one or more computer servers for the purposes of transaction processing, marketing, accounting, and information analysis.

According to the fourth network type, there is a coupon processing system in a system including a computer network connecting a server system, a plurality of store controllers or store point of sale devices, a plurality of customers each possessing a portable electronic device, a portable electronic device receives one or more coupons or description of one or more coupons in a signal (message set) thru the computer network from a computer (server), the portable electronic device accesses or stores eligibility for one or more coupons within the device. The coupon processing system comprises a computer server periodically downloads consumer coupon eligibility information to the point of sale system; a portable electronic device in the proximity of a near field communication receiver associated or contained within a point of sale system (external or internal); a near field communication receiver associated with the point of sale system receives the coupon request communicated by the portable electronic device; a determiner within the point of sale system connected to the computer network determines whether a coupon corresponds to the coupon signal has been previously processed; a determiner within point of sale system adjusts the total sales receipt; and periodically the point of sale system communicates the redemption of the coupon event across the computer network to one or more computer servers for the purposes of transaction processing, marketing, accounting, and information analysis.

According to the first network type, there is a loyalty event processing system in a system including a computer network connecting a server system, a plurality of store controllers and optionally regional controllers, a plurality of store point of sale devices, a plurality of customers each possessing a portable electronic device, a portable electronic device receives one or more loyalty events or a description of one or more loyalty events in a signal (message set) thru a communication network from a computer, the portable electronic device accesses a computer via the communication network or retains in memory eligibility for one or more loyalty events within the device. The loyalty event processing system comprises a portable electronic device in the proximity of a near field communication receiver associated with a point of sale device; a near field communication receiver connected to (or alternatively contained within) a point of sale system receives the loyalty event request communicated by the portable electronic device; a store controller receives the loyalty event request communicated by the point of sale system; a determiner within server connected to the computer network determines whether a loyalty event is eligible for processing or has been previously processed; a transmitter within the server sends the updated loyalty event information or alternatively, processes a loyalty award redemption thru the network to point of sale; and periodically the point of sale system communicates the loyalty event across a network to one or more computer servers for the purposes of transaction processing, marketing, accounting, and information analysis.

According to the first network type, there is a loyalty event processing system in a system including a computer network connecting a server system, a plurality of store controllers and optionally regional controllers, a plurality of store point of sale devices, a plurality of customers each possessing a portable electronic device, a portable electronic device receives one or more loyalty events or a description of one or more loyalty events in a signal (message set) thru a communication network from a computer, the portable electronic device accesses a computer via the communication network or retains in memory eligibility for one or more loyalty events within the device. The loyalty event processing system comprises a computer server periodically downloads consumer loyalty event eligibility information to the store controller (optionally to or via a regional controller); a portable electronic device in the proximity of a near field communication receiver associated with a point of sale device; a near field communication receiver connected to (or alternatively contained within) a point of sale system receives the loyalty event request communicated by the portable electronic device; a store controller receives the loyalty event request communicated by the point of sale system; a determiner within the store controller (optionally regional controller) connected to the computer network determines whether a loyalty event is eligible for processing or has been previously processed; and a transmitter within the store controller (optionally regional controller) sends the updated loyalty event information or alternatively processes a loyalty award redemption thru the network to point of sale; and periodically the point of sale system communicates the updated loyalty event or redemption of the loyalty event across a network to the store controller (optionally regional controller); and a store controller (optionally regional controller) periodically transmits redemption information to one or more computer servers for the purposes of transaction processing, marketing, accounting, and information analysis.

According to the first network type, type there is a loyalty event processing system in a system including a computer network connecting a server system, a plurality of store controllers and optionally regional controllers, a plurality of store point of sale devices, a plurality of customers each possessing a portable electronic device, a portable electronic device receives one or more loyalty events or a description of one or more loyalty events in a signal (message set) thru a communication network from a computer, the portable electronic device accesses a computer via the communication network or retains in memory eligibility for one or more loyalty events within the device. The loyalty event processing system comprises a computer server periodically downloads consumer loyalty event eligibility information thru the store controller (optionally the regional controller) system to the point of sale system; a portable electronic device in the proximity of a near field communication receiver associated with a point of sale device; a near field communication receiver connected to (or alternatively contained within) a point of sale system receives the loyalty event request communicated by the portable electronic device; a determiner within the point of sale system connected to the computer network determines whether a loyalty event corresponds to the loyalty event signal has been previously processed; a determiner within the point of sale system adjusts loyalty event information and conditionally adjusts the total sales receipt; periodically the point of sale system communicates the updated the loyalty event information across the computer network to the store controller (optionally regional controller); and a store controller (optionally regional controller) periodically transmits redemption information to one or more computer servers for the purposes of transaction processing, marketing, accounting, and information analysis.

According to the second network type, there is a loyalty event processing system in a system including a computer network connecting a server system, a plurality of store point of sale devices, a plurality of customers each possessing a portable electronic device, a portable electronic device receives one or more loyalty events or a description of one or more loyalty events in a signal (message set) thru a communication network from a computer, the portable electronic device accesses a computer via the communication network or retains in memory eligibility for one or more loyalty events within the device. The loyalty event processing system comprises a portable electronic device in the proximity of a near field communication receiver associated with a point of sale device; a near field communication receiver connected to (or alternatively contained within) the point of sale receives the loyalty event request communicated by the portable electronic device; a determiner within the point of sale system connected to the computer network determines whether a loyalty event corresponds to the loyalty event signal has been previously processed; and a transmitter sends loyalty event information thru the computer network to point of sale adjusting loyalty event information and conditionally adjusting the total sales receipt; and periodically the point of sale system communicates the loyalty event across a network to one or more computer servers for the purposes of transaction processing, marketing, accounting, and information analysis.

According to the second network type, there is a loyalty event processing system in a system including a computer network connecting a server system, a plurality of store point of sale devices, a plurality of customers each possessing a portable electronic device, a portable electronic device receives one or more loyalty events or a description of one or more loyalty events in a signal (message set) thru a communication network from a computer, the portable electronic device accesses a computer via the communication network or retains in memory eligibility for one or more loyalty events within the device. The loyalty event processing system comprises a computer server periodically downloads consumer loyalty event eligibility information to the point of sale system; a portable electronic device in the proximity of a near field communication receiver associated with a point of sale device; a near field communication receiver connected to (or alternatively contained within) the point of sale receives the loyalty event request communicated by the portable electronic device; a determiner within the point of sale system connected to the computer network determines whether a loyalty event corresponds to the loyalty event signal has been previously processed; a determiner within the server point of sale system that adjusts the loyalty event information and conditionally adjusts the total sales receipt; and periodically the point of sale system communicates the redemption of the loyalty event across the computer network to one or more computer servers for the purposes of transaction processing, marketing, accounting, and information analysis.

According to the third network type, there is a loyalty event processing system in a system including a computer network connecting a server system, a plurality of terminal systems, a plurality of customers each possessing a portable electronic device, a portable electronic device receives one or more loyalty events or a description of one or more loyalty events in a signal (message set) thru a communication network from a computer, the portable electronic device accesses a computer via the communication network or retains in memory eligibility for one or more loyalty events within the device. The loyalty event processing system comprises a portable electronic device in the proximity of a near field communication receiver associated with a terminal system; a near field communication receiver (external or internal) associated with a terminal system receives the loyalty event request communicated by the portable electronic device; a determiner within the server computer connected to computer network determines whether a loyalty event corresponds to the loyalty event signal has been previously processed; and a transmitter that sends loyalty event information thru the computer network to terminal system adjusting loyalty event information and conditionally adjusting the total sales receipt; and periodically the terminal system communicates the loyalty event across a network to one or more computer servers for the purposes of transaction processing, marketing, accounting, and information analysis.

According to the third network type, there is a loyalty event processing system in a system including a computer network connecting a server system, a plurality of terminal systems, a plurality of customers each possessing a portable electronic device, a portable electronic device receives one or more loyalty events or a description of one or more loyalty events in a signal (message set) thru a communication network from a computer, the portable electronic device accesses a computer via the communication network or retains in memory eligibility for one or more loyalty events within the device. The loyalty event processing system comprises a computer server periodically downloads consumer loyalty event eligibility information to the terminal system; a portable electronic device in the proximity of a near field communication receiver associated with a terminal (external or internal); a near field communication receiver associated with the terminal receives the loyalty event request communicated by the portable electronic device; a determiner within the terminal system determines whether a loyalty event corresponds to the loyalty event signal has been previously processed; a determiner within terminal system adjusts the loyalty event information and conditionally adjusts the total sales receipt; and periodically the terminal system communicates the redemption of the loyalty event across the computer network to one or more computer servers for the purposes of transaction processing, marketing, accounting, and information analysis.

According to the fourth network type, there is a loyalty event processing system in a system including a computer network connecting a server system, a plurality of point of sale systems, a plurality of customers each possessing a portable electronic device, a portable electronic device receives one or more loyalty events or a description of one or more loyalty events in a signal (message set) thru a communication network from a computer, the portable electronic device accesses a computer via the communication network or retains in memory eligibility for one or more loyalty events within the device. The loyalty event processing system comprises a portable electronic device in the proximity of a near field communication receiver associated or contained within a point of sale device; a near field communication receiver (external or internal) associated with a point of sale system receives the loyalty event request communicated by the portable electronic device; a determiner within the server computer connected to computer network determines whether a loyalty event corresponds to the loyalty event signal has been previously processed; a transmitter that sends loyalty event information thru the computer network to point of sale system that adjusts the loyalty event information and conditionally adjusts the total sales receipt; and periodically the point of sale system communicates the loyalty event across a network to one or more computer servers for the purposes of transaction processing, marketing, accounting, and information analysis.

According to the fourth network type, there is a loyalty event processing system in a system including a computer network connecting a server system, a plurality of store controllers or store point of sale devices, a plurality of customers each possessing a portable electronic device, a portable electronic device receives one or more loyalty events or description of one or more loyalty events in a signal (message set) thru the computer network from a computer (server), the portable electronic device accesses or stores eligibility for one or more loyalty events within the device. The loyalty event processing system comprises a computer server periodically downloads consumer loyalty event eligibility information to the point of sale system; a portable electronic device in the proximity of a near field communication receiver associated or contained within a point of sale system (external or internal); a near field communication receiver associated with the point of sale system receives the loyalty event request communicated by the portable electronic device; a determiner within the point of sale system determines whether a loyalty event corresponds to the loyalty event signal has been previously processed; a determiner within point of sale system adjusts the loyalty event information and conditionally adjusts the total sales receipt; and periodically the point of sale system communicates the redemption of the loyalty event across the computer network to one or more computer servers for the purposes of transaction processing, marketing, accounting, and information analysis.

According to first network type, there is a voucher processing system in a system including a computer network connecting a server system, a plurality of store controllers and optionally regional controllers, a plurality of store point of sale devices, a plurality of customers each possessing a portable electronic device, a portable electronic device receives one or more prepaid or partially prepaid vouchers in a signal (message set) thru a communication network from a computer, the portable electronic device accesses a computer via the communication network or retains in memory eligibility for one or more prepaid or partially prepaid vouchers within the device. The voucher processing system comprises a portable electronic device in the proximity of a near field communication receiver associated with a point of sale device; a near field communication receiver connected to (or alternatively contained within) a point of sale system receives the prepaid or partially prepaid vouchers event request communicated by the portable electronic device; a store controller receives the prepaid or partially prepaid vouchers request communicated by the point of sale system; a determiner within server connected to the computer network determines whether a prepaid or partially prepaid voucher is eligible for processing or has been previously processed; optionally (i.e. dependent claim) a second determiner within server connected to the computer network that for an eligible prepaid or partially prepaid voucher determines the value or alternatively for what product(s) or service(s) the prepaid or partially prepaid voucher may be processed for; a transmitter within the server processes the prepaid or partially prepaid voucher award redemption thru the network to point of sale; and periodically the point of sale system communicates the prepaid or partially prepaid voucher redemption across a network to one or more computer servers for the purposes of transaction processing, marketing, accounting, and information analysis.

According to the first network type, there is a voucher processing system in a system including a computer network connecting a server system, a plurality of store controllers and optionally regional controllers, a plurality of store point of sale devices, a plurality of customers each possessing a portable electronic device, a portable electronic device receives one or more prepaid or partially prepaid vouchers in a signal (message set) thru a communication network from a computer, the portable electronic device accesses a computer via the communication network or retains in memory eligibility for one or more prepaid or partially prepaid vouchers within the device. The voucher processing system comprises a computer server periodically downloads consumer prepaid or partially prepaid voucher eligibility information to the store controller (optionally to or via a regional controller); a portable electronic device in the proximity of a near field communication receiver associated with a point of sale device; a near field communication receiver connected to (or alternatively contained within) a point of sale system receives a prepaid or partially prepaid voucher request communicated by the portable electronic device; a store controller receives the a prepaid or partially prepaid voucher request communicated by the point of sale system; a determiner within the store controller (optionally regional controller) connected to the computer network determines whether a prepaid or partially prepaid voucher is eligible for processing or has been previously processed; optionally (i.e. dependent claim) a second determiner within store controller connected to the computer network that for an eligible prepaid or partially prepaid voucher determines the value or alternatively for what product(s) or service(s) the prepaid or partially prepaid voucher may be processed for; a transmitter within the store controller (optionally regional controller) sends the updated a prepaid or partially prepaid voucher information or alternatively processes a loyalty award redemption thru the network to point of sale; periodically the point of sale system communicates the updated voucher redemption of the a prepaid or partially prepaid voucher, conditionally adjusts the total sales receipt, and communicates across a network to the store controller (optionally regional controller); and a store controller (optionally regional controller) periodically transmits voucher redemption information to one or more computer servers for the purposes of transaction processing, marketing, accounting, and information analysis.

According to the first network type, there is a voucher processing system in a system including a computer network connecting a server system, a plurality of store controllers and optionally regional controllers, a plurality of store point of sale devices, a plurality of customers each possessing a portable electronic device, a portable electronic device receives one or more prepaid or partially prepaid vouchers in a signal (message set) thru a communication network from a computer, the portable electronic device accesses a computer via the communication network or retains in memory eligibility for one or more prepaid or partially prepaid vouchers within the device. The voucher processing system comprises a computer server periodically downloads consumer a prepaid or partially prepaid voucher eligibility information thru the store controller (optionally the regional controller) system to the point of sale system; a portable electronic device in the proximity of a near field communication receiver associated with a point of sale device; a near field communication receiver connected to (or alternatively contained within) a point of sale system receives a prepaid or partially prepaid voucher request communicated by the portable electronic device; a determiner within the point of sale system connected to the computer network determines whether a prepaid or partially prepaid voucher corresponds to a voucher event signal has been previously processed; optionally (i.e. dependent claim) a second determiner within point of sale system connected to the computer network that for an eligible prepaid or partially prepaid voucher determines the value or alternatively for what product(s) or service(s) the prepaid or partially prepaid voucher may be processed for; a determiner within the point of sale system processes prepaid or partially prepaid voucher information and conditionally adjusts the total sales receipt; periodically the point of sale system communicates the updated the prepaid or partially prepaid voucher information across the computer network to the store controller (optionally regional controller); and a store controller (optionally regional controller) periodically transmits redemption information to one or more computer servers for the purposes of transaction processing, marketing, accounting, and information analysis.

According to the second network type, there is a voucher processing system in a system including a computer network connecting a server system, a plurality of store point of sale devices, a plurality of customers each possessing a portable electronic device, a portable electronic device receives one or more prepaid or partially prepaid vouchers or stores in memory a record of the eligibility of prepaid or partially prepaid vouchers in a signal (message set) thru a communication network from a computer, the portable electronic device accesses a computer via the communication network or retains in memory eligibility for one or more prepaid or partially prepaid vouchers within the device. The voucher processing system comprises a portable electronic device in the proximity of a near field communication receiver associated with a point of sale device; a near field communication receiver connected to (or alternatively contained within) the point of sale receives one or more prepaid or partially prepaid vouchers communicated by the portable electronic device; a determiner within the point of sale system connected to the computer network determines whether one or more prepaid or partially prepaid vouchers corresponds to a voucher event signal has been previously processed; optionally (i.e. dependent claim) a second determiner within point of sale system connected to the computer network that for an eligible prepaid or partially prepaid voucher determines the value or alternatively for what product(s) or service(s) the prepaid or partially prepaid voucher may be processed for; a transmitter sends one or more prepaid or partially prepaid vouchers thru the computer network to point of sale adjusting the total sales receipt; and periodically the point of sale system communicates the voucher redemption event across a network to one or more computer servers for the purposes of transaction processing, marketing, accounting, and information analysis.

According to the second network type, there is a voucher processing system in a system including a computer network connecting a server system, a plurality of store point of sale devices, a plurality of customers each possessing a portable electronic device, a portable electronic device receives one or more prepaid or partially prepaid vouchers or stores in memory a record of the eligibility of prepaid or partially prepaid vouchers in a signal (message set) thru a communication network from a computer, the portable electronic device accesses a computer via the communication network or retains in memory eligibility for one or more prepaid or partially prepaid vouchers within the device. The voucher processing system comprises a computer server periodically downloads voucher event eligibility information to the point of sale system; a portable electronic device in the proximity of a near field communication receiver associated with a point of sale device; a near field communication receiver connected to (or alternatively contained within) the point of sale receives a request for one or more prepaid or partially prepaid vouchers communicated by the portable electronic device; a determiner within the point of sale system connected to the computer network determines whether a voucher redemption request corresponds to the a voucher event signal has been previously processed; optionally (i.e. dependent claim) a second determiner within point of sale system connected to the computer network that for an eligible prepaid or partially prepaid voucher determines the value or alternatively for what product(s) or service(s) the prepaid or partially prepaid voucher may be processed for; a determiner within the server point of sale system that redeems one or more prepaid or partially prepaid vouchers and adjusts the total sales receipt; and periodically the point of sale system communicates the voucher redemption event across the computer network to one or more computer servers for the purposes of transaction processing, marketing, accounting, and information analysis.

According to the third network type, there is a voucher event processing system in a system including a computer network connecting a server system, a plurality of terminal systems, a plurality of customers each possessing a portable electronic device, a portable electronic device receives one or more prepaid or partially prepaid vouchers or stores in memory a record of the eligibility of prepaid or partially prepaid vouchers in a signal (message set) thru a communication network from a computer, the portable electronic device accesses a computer via the communication network or retains in memory eligibility for one or more prepaid or partially prepaid vouchers or stores in memory a record of the eligibility of prepaid or partially prepaid vouchers within the device. The voucher event processing system comprises a portable electronic device in the proximity of a near field communication receiver associated with a terminal system; a near field communication receiver (external or internal) associated with a terminal system receives one or more prepaid or partially prepaid voucher redemption request communicated by the portable electronic device; a determiner within the server computer connected to computer network determines whether a voucher redemption event corresponds to the voucher redemption event signal has been previously processed; optionally (i.e. dependent claim) a second determiner within the sever computer connected to the computer network that for an eligible prepaid or partially prepaid voucher determines the value or alternatively for what product(s) or service(s) the prepaid or partially prepaid voucher may be processed for; a transmitter that sends event information for one or more prepaid or partially prepaid vouchers thru the computer network to terminal system, conditionally adjusting the total sales receipt; and periodically the terminal system communicates the voucher redemption event across a network to one or more computer servers for the purposes of transaction processing, marketing, accounting, and information analysis.

According to the third network type, there is a voucher event processing system in a system including a computer network connecting a server system, a plurality of terminal systems, a plurality of customers each possessing a portable electronic device, a portable electronic device receives one or more prepaid or partially prepaid vouchers or stores in memory a record of the eligibility of prepaid or partially prepaid vouchers in a signal (message set) thru a communication network from a computer, the portable electronic device accesses a computer via the communication network or retains in memory eligibility for one or more prepaid or partially prepaid vouchers or stores in memory a record of the eligibility of prepaid or partially prepaid vouchers within the device. The voucher event processing system comprises a computer server periodically downloads prepaid or partially prepaid voucher eligibility information to the terminal system; a portable electronic device in the proximity of a near field communication receiver associated with a terminal (external or internal); a near field communication receiver associated with the terminal receives the voucher eligibility request for one or more prepaid or partially prepaid vouchers, communicated by the portable electronic device; a determiner within the terminal system determines whether a voucher redemption request corresponds to a voucher that has been previously processed; optionally (i.e. dependent claim) a second determiner within terminal system connected to the computer network that for an eligible prepaid or partially prepaid voucher determines the value or alternatively for what product(s) or service(s) the prepaid or partially prepaid voucher may be processed for; a determiner within terminal system redeems and adjusts the total sales receipt; and periodically the terminal system communicates the redemption of one or more prepaid or partially prepaid vouchers across the computer network to one or more computer servers for the purposes of transaction processing, marketing, accounting, and information analysis.

According to the fourth network type, there is a voucher redemption and processing system in a system including a computer network connecting a server system, a plurality of point of sale systems, a plurality of customers each possessing a portable electronic device, a portable electronic device receives one or more prepaid or partially prepaid vouchers or stores in memory a record of the eligibility of prepaid or partially prepaid vouchers in a signal (message set) thru a communication network from a computer, the portable electronic device accesses a computer via the communication network or retains in memory eligibility for prepaid or partially prepaid vouchers within the device. The voucher redemption and processing system comprises a portable electronic device in the proximity of a near field communication receiver associated or contained within a point of sale device; a near field communication receiver (external or internal) associated with a point of sale system receives a request for one or more prepaid or partially prepaid vouchers communicated by the portable electronic device; a determiner within the server computer connected to computer network determines whether a voucher redemption event corresponds to the voucher event signal has been previously processed; optionally (i.e. dependent claim) a second determiner within the server computer connected to the computer network that for an eligible prepaid or partially prepaid voucher determines the value or alternatively for what product(s) or service(s) the prepaid or partially prepaid voucher may be processed for; a transmitter that sends voucher eligibility event information thru the computer network to point of sale system that conditionally redeems one or more prepaid or partially prepaid vouchers and adjusts the total sales receipt; and periodically the point of sale system communicates the voucher redemption event across a network to one or more computer servers for the purposes of transaction processing, marketing, accounting, and information analysis.

According to the fourth network type, there is a voucher redemption and processing system in a system including a computer network connecting a server system, a plurality of point of sale systems, a plurality of customers each possessing a portable electronic device, a portable electronic device receives one or more prepaid or partially prepaid vouchers or stores in memory a record of the eligibility of prepaid or partially prepaid vouchers in a signal (message set) thru a communication network from a computer, the portable electronic device accesses a computer via the communication network or retains in memory eligibility for prepaid or partially prepaid vouchers within the device. The voucher redemption and processing system comprises a computer server periodically downloads voucher redemption eligibility information to the point of sale system; a portable electronic device in the proximity of a near field communication receiver associated or contained within a point of sale system (external or internal); a near field communication receiver associated with the point of sale system receives the voucher eligibility request for one or more prepaid or partially prepaid vouchers, communicated by the portable electronic device; a determiner within the point of sale system determines whether a voucher redemption requests corresponds to a voucher redemption signal that has been previously processed; optionally (i.e. dependent claim) a second determiner within point of sale system connected to the computer network that for an eligible prepaid or partially prepaid voucher determines the value or alternatively for what product(s) or service(s) the prepaid or partially prepaid voucher may be processed for; a determiner within point of sale system conditionally redeems the voucher for a prepaid or partially prepaid voucher and conditionally adjusts the total sales receipt; and periodically the point of sale system communicates the redemption of one or more prepaid or partially prepaid vouchers across the computer network to one or more computer servers for the purposes of transaction processing, marketing, accounting, and information analysis.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. In a system including a server operated on behalf of a first entity, a store operated on behalf of a second entity, the first entity being non-affiliated with the second entity, a plurality of customers each possessing a portable electronic device, each portable electronic device configured to receive a first signal thru a communication network from a computer, each portable electronic device configured to access the computer via the communication network, a processing system in the store, the processing system comprising:
a near field communication receiver configured to receive the first signal from the portable electronic device; and
circuitry configured to receive the first signal from the near field communication, receiver, send the first signal to the server, receive a second signal from the server, and cause a point of sale system to display an amount due, the amount due depending on the second signal.

2. The processing system of claim 1 wherein the first signal includes information about a coupon.

3. The processing system of claim 1 wherein the first signal includes information about a loyalty event.

4. The processing system of claim 1 wherein the first signal includes information about a voucher.

5. The processing system of claim 1 wherein the server in located outside of the store.

6. The processing system of claim 1, further including
the server; and
point of sale circuitry that conditionally communicates the first signal across a computer network to the server,
wherein the server is configured to
periodically download consumer eligibility information,
determine whether the first signal has been previously processed, and
periodically transmit information to a server outside of the store for the purposes of transaction processing, marketing, accounting, and information analysis.

7. In a system including a server operated on behalf of a first entity, a store operated on behalf of a second entity, the first entity being non-affiliated with the second entity, a plurality of customers each possessing a portable electronic device, each portable electronic device configured to receive a first signal thru a communication network from a computer, each portable electronic device configured to access the computer via the communication network, a method performed in the store, the method comprising:
receiving a first signal from the portable electronic device, by using a near field communication circuitry; and
sending the received first signal to the server;
receiving a second signal from the server; and
displaying an amount due, responsive to the received the second signal.

8. The method of claim 7 wherein the first signal includes information about a coupon.

9. The method of claim 7 wherein the first signal includes information about a loyalty event.

10. The method of claim 7 wherein the first signal includes information about a voucher.

11. The method of claim 7 wherein the server in located outside of the store.

12. The method of claim 7, further including
conditionally communicating the first signal across a computer network to the server;
periodically downloading consumer eligibility information;
determining whether the first signal has been previously processed, and
periodically transmitting information to a server outside of the store for the purposes of transaction processing, marketing, accounting, and information analysis.

13. In a system including a server operated on behalf of a first entity, a store operated on behalf of a second entity, the first entity being non-affiliated with the second entity, a plurality of customers each possessing a portable electronic device, each portable electronic device configured to receive a first signal thru a communication network from a computer, each portable electronic device configured to access the computer via the communication network, a processing system in the store, the processing system comprising:
means for receiving a first signal from the portable electronic device, by using a near field communication circuitry;
means for sending the received first signal to the server;
means for receiving a second signal from the server; and
means for displaying an amount due, responsive to the received the second signal.

14. The processing system of claim 13 wherein the first signal includes information about a coupon.

15. The processing system of claim 13 wherein the first signal includes information about a loyalty event.

16. The processing system of claim 13 wherein the first signal includes information about a voucher.

17. The processing system of claim 13 wherein the server in located outside of the store.

18. The processing system of claim 13, further including
means for conditionally communicating the first signal across a computer network to the server;
means for periodically downloading consumer eligibility information;
means for determining whether the first signal has been previously processed, and
means for periodically transmitting information to a server outside of the store for the purposes of transaction processing, marketing, accounting, and information analysis.
